(19) United States
(12) Patent Application Publication
(10) Pub. No.: US 2025/0162885 A1
(43) Pub. Date: May 22, 2025

(54) METHOD FOR SURFACE MODIFICATION AND DENSIFICATION OF LOW BULK DENSITY MATERIALS

(71) Applicant: ARKEMA INC., King of Prussia, PA (US)

(72) Inventor: Christian G. BECKER, King of Prussia, PA (US)

(73) Assignee: ARKEMA INC., King of Prussia, PA (US)

(21) Appl. No.: 18/843,626

(22) PCT Filed: Jan. 31, 2023
(86) PCT No.: PCT/US2023/011968

§ 371 Date: Sep. 3, 2024

Related U.S. Application Data
(60) Provisional application No. 63/315,606, filed on Mar. 2, 2022.

(51) Int. Cl. C01B 33/18

(52) U.S. Cl. CPC C01B 33/18; C01P 2006/11

(57) ABSTRACT

There is provided a method for increasing the bulk density of low bulk density materials by gently admixing a low bulk density material and a liquid and thereafter removing substantially all of the liquid, for example, by evaporation.

### BACKGROUND OF THE INVENTION

The present invention relates to a method for the surface modification and densification of low bulk density materials such as fumed (or pyrogenic) silica. More particularly, the present invention relates to a method for increasing the bulk density of fumed silica by contacting fumed silica with a suitable liquid under gentle blending conditions and thereafter evaporating the liquid so as to provide a more dense fumed silica material.

Fumed silica is a well-known reinforcing agent or filler commonly employed to improve the physical properties of a variety of materials. There is an increase in demand for fumed silica for numerous applications such as those related to silicone elastomers, adhesives, sealants, and unsaturated polyester resin (UPR). UPR is used extensively for making fiber-reinforced plastics in building construction, pipes, tanks, and automotive applications. They also find application in fuel storage tanks, cooling tower components, beams, ladder rails, boat hulls, decks, and small automobile parts (both interior and exterior). Fumed silica is suitable for use in the reinforcement of silicone rubbers, including heat-cured rubber, high temperature vulcanizing and liquid silicone rubber in which it can increase hardness, tensile strength and elongation.

Fumed silica is also used as a multi-functional additive in the pharmaceutical and nutraceutical industries. Its glidant and anti-static properties help improve the flow properties of powders and reduce friction and static charges in high-speed tableting and capsule machines. Fumed silica adheres readily to hydrophilic ingredients, functioning as an excellent glidant. It is also used as a disintegrant, filler, lubricant, binder, and a sorbent in tablets, capsules, and powders. Fumed silica is also used in liquids, creams, and suspensions. Since it also absorbs water off the surface of particles, it is suited as an anti-caking agent.

Fumed silica comprises silicon dioxide particles in extremely finely divided, powder form. The specific surface area typically ranges from about 100 to about 400 square meters per gram.

A major disadvantage of such low bulk density materials is that they are relatively expensive to ship and store because of their light, fluffy powdery structure. A compounder or formulator, for example, who requires large quantities of such fillers, must pay premium rates for shipping because shipping containers such as rail cars cannot contain large amounts on a weight basis. Moreover, once the compounder or formulator receives such fillers they must pay for a suitable storage area such as a warehouse, silo or the like. Accordingly, it would be highly desirable to provide a means for increasing the bulk density of such low bulk density materials in order to reduce transportation and storage costs.

There are mechanical means whereby the bulk density of a powdered material such as fumed silica is increased. For example, U.S. Pat. No. 3,114,930 by Oldham et al. relies on the use of vacuum to remove air from an aerated powdered material thereby reducing the density. U.S. Pat. No. 3,664,385 by Carter compacts finely divided particulate matter by utilizing a rotating screw feeder. U.S. Pat. No. 4,325,686 by Leon et al. provides densification by employing a pair of opposed gas-permeable belts arranged on either side of a common axis so as to define a generally convergent densifying zone between their adjacent faces.

While the bulk density of many materials can be increased by mechanical means, there nevertheless remain certain shortcomings and disadvantages. For example, in the case of fumed silica, if the density is increased by a mechanical apparatus beyond about 6 pounds per cubic foot, unacceptably high amounts of agglomerates and grit are formed. Moreover, it has also been found that fumed silica densified by mechanical means no longer disperses as well in silicone polymer as the original lower bulk density fumed silica.

U.S. Pat. No. 4,780,108 by Razzano discloses a non-mechanical method for increasing the bulk density of low-density bulk materials by intensely admixing a low bulk density material and an organic or organopolysiloxane liquid and thereafter removing the organic or organopolysiloxane liquid. Razzano further discloses that such silicas no longer disperse as well in silicone compositions as the original silica with lower bulk density.

U.S. Pat. No. 4,898,898, by Fitzgerald et al. provides for blending fumed silica or other powdered materials with a silicone polymer so as to provide free flowing powders having higher densities than can be obtained by mechanical means.

The present inventor has surprisingly found that adding an aqueous liquid such as water or water containing soluble compounds (hydrogen peroxide, acids, bases, alcohols, esters, ketones, salts, soluble polymers, etc.) to a low density, powdered material such as fumed silica dropwise or via spraying with gentle agitation and thereafter evaporating such liquid causes a substantial increase in the bulk density of the powdered material. The material is densified while it retains the homogeneity of the fine powdery form of the low bulk density material. That is, without causing unacceptably high amounts of agglomerates and grit. The method of the present invention provides for a densified material that exhibits substantially the same properties as the original low bulk density material.

### SUMMARY OF THE INVENTION

It is one object of the present invention to provide a method for increasing the bulk density of a low bulk density fumed silica material without altering its absorption or dispersion properties.

It is another object of the present invention to provide a method for increasing the bulk density of a low bulk density material while maintaining its homogeneity in a powdery form i.e., without forming unacceptably high amounts of agglomerates and grit.

In accordance with the present invention there is provided a method for increasing the bulk density of low bulk density fumed silica materials, comprising:
(A) adding an aqueous, preferably polar liquid to a low bulk density, preferably fumed silica material dropwise or via spraying;
(B) gently mixing said low bulk density material and said aqueous liquid for an amount of time effective to decrease the volume of the original low bulk density material while maintaining the homogeneity of the low bulk density material; and
(C) removing substantially all of said aqueous liquid so as to provide a material having an increased bulk density.

In a particularly preferred embodiment, the low bulk density material is fumed silica and the aqueous liquid is water or water containing soluble compounds such as hydrogen peroxide, acids, bases, alcohols, esters, ketones, salts, soluble polymers, etc. The water-soluble compound can also include surfactants, enzymes, etc. suitable for cleaning products. The water soluble compound can also include colorants, fragrances, etc.

### DESCRIPTION OF THE INVENTION

The present invention provides a method for increasing the bulk density of low bulk density materials, comprising:
(A) adding an aqueous, preferably polar liquid to a low bulk density fumed silica material dropwise of via spraying;
(B) gently mixing said low bulk density material and said aqueous liquid for an amount of time effective to decrease the volume of the original low bulk density material while maintaining the homogeneity of the material; and
(C) removing substantially all of said aqueous liquid so as to provide a material having an increased bulk density.

In general, the low bulk density material can be any composition that can be generally classified as a “powder”. For purposes of the present invention, powder is defined as any solid, dry material of extremely small particle size ranging down to colloidal dimensions, prepared either by comminuting larger units (mechanical grinding), by combustion (e.g., fumed silica), or by precipitation from a chemical reaction.

Examples of powders, which can be employed in the practice of the present invention, include fumed silica. The fumed (pyrogenic) silica can be hydrophilic or hydrophobic (treated).

Of particular interest is fumed silica, which is the most preferred low bulk density material for use in practicing the present invention. For convenience, hereinafter the term fumed silica, low bulk density material and low bulk density fumed silica will be understood to include any materials within the foregoing definition of a powder.

Aqueous liquids, which can be mixed with the aforementioned low bulk density materials in order to effect the advantageous results of the present invention, may be polar or non-polar. With treated silica (i.e., hydrophobic silica) non-polar liquids would be needed in order to wet the product. With non-treated silica (i.e., hydrophilic silica), polar liquids would be preferred. Varying ranges of liquid polarity can be used based on the hydrophobicity/hydrophilicity ratio of the silica material. The preferred aqueous liquids are polar liquids such as water or water containing soluble compounds such as hydrogen peroxide, acids, bases, alcohols, esters, ketones, salts, soluble polymers, etc. Preferred aqueous liquids can also include surfactants and enzymes suitable for cleaning products. Most preferred aqueous liquids are water and aqueous solutions of hydrogen peroxide. The concentration of the hydrogen peroxide aqueous solutions is not limited by the present invention. Preferably, the hydrogen peroxide concentration can range from 0.1% to 70% hydrogen peroxide, more preferably from 35% to 70%.

Those skilled in the art will appreciate that many other powders and aqueous liquids not specifically listed herein can be utilized to practice the present invention without departing from the intended scope of the appended claims.

In practicing the invention, the low bulk density fumed silica material is placed in a suitable mixing vessel. The aqueous liquid effective for densifying the low bulk density fumed silica material is added dropwise or by spraying it onto the fumed silica followed by gentle mixing to provide homogeneity. The addition of the liquid is preferably done while agitation is taking place so as to provide good homogeneity and no wet spots that would lead to agglomerate formation. However, it is within the scope of the present invention to use minimal agitation and then have more vigorous blending. Once the liquid is added, it is preferably followed by a period of mixing for homogeneity (in order to break up wet spot and any weak agglomerates). The duration and intensity of the mixing will vary depending on the batch size and amount of liquid added. The application of the aqueous liquid and gentle mixing can occur in a series of sequential steps comprising repeating the steps of aqueous liquid addition and gentle mixing until a desired reduction in volume of the low bulk density fumed silica material is achieved. Thereafter, the material is dried to remove the aqueous liquid.

The present inventor discovered that gentle mixing of the low bulk density material and aqueous liquid resulted in a homogenous material i.e., one substantially free of agglomerates and grit as is the original powdery material. The homogenous material is a material that retains substantially all of the absorption characteristics of the original low bulk density material while minimizing or eliminating the formation of agglomerates and grit. The resulting homogenous material is a reduced volume, densified material that remains powdery, free flowing and is substantially free of agglomerates and/or grit.

By “an effective amount of aqueous liquid” is meant an amount of aqueous liquid sufficient to decrease the volume of the original low bulk density fumed silica material to a desire level. What constitutes an effective amount of liquid will vary depending upon the low bulk density fumed silica material employed, the aqueous liquid employed and the desired volume/density modification. Those skilled in the art will be able to make such determination without undue experimentation. As a general guideline, the minimum amount of aqueous liquid that can be employed must be sufficient to “wet” or contact substantially all of the particles of the low bulk density material, thereby causing the volume of the low bulk density material to decrease upon gentle mixing. The maximum amount of liquid desired is that which is sufficient to show that excess liquid is present after mixing. There is, however, no upper bound since the liquid is removed, for example by evaporation, after gentle mixing of the low bulk density material and aqueous liquid is completed. The amount of liquid required will vary dependent on the specifications of the fumed silica (e.g., surface area) and the type of liquid (e.g., polarity). Polar and non-polar liquids can be employed. Non-limiting examples of polar liquids include water, acetone and 1-butanol. Non-limiting examples of nonpolar liquids include benzene, n-hexane and carbon tetrachloride.

Other parameters, such as the intensity of the mixing for example, can have an impact in the density increase process as well. In accordance with the present invention, such mixing should be gentle in order to avoid an over densification leading to an unworkable saturated material wet in appearance. The resulting product should not appear saturated and while having some integrity, should still be flowable upon blending after addition of the liquid. It is believed that too much shear as by intense mixing will alter the physical structure or agglomerates of the fumed silica. This, in turn, strongly modifies the overall properties of the final product.

With particular reference to a mixture of fumed silica and aqueous hydrogen peroxide, there should be present at least about 15% by weight, and more preferably, at least about 60% by weight, aqueous hydrogen peroxide based on the weight of fumed silica. As can be gathered from the examples set forth herein below, an effective amount of liquid may be as much as three times, by weight, as fumed silica.

Mixing of the low bulk density fumed silica material and aqueous liquid is preferably effected in a mixing vessel, which provides gentle agitation such as a mixer or blender operated intermittently, i.e. for short periods of time, so as to insure that substantially all of the particulate matter is wetted with the liquid. However, for purposes of the present invention the terms “mixing vessel” or “mixing in a suitable vessel” and other comparable terminology is intended to include any means which effects wetting of the low bulk density material by the liquid. For example, methods such as rolling, spraying, fluidizing and agitating are all acceptable. Agitation and powder blending can be provided by methods including but not limited to ribbon blenders, paddle blenders and their equivalents with the proviso that the agitation/mixing be gentle and not aggressive. The skilled artisan will also appreciate that the present process can be practiced in either a batch or continuous manner.

The time required to effect mixing must be sufficient to decrease the volume of the original low bulk density material. Accordingly, the mixing time may range from as little as 5 or 10 seconds to an hour or more. The mixing time will, of course, depend upon the particular low bulk density material, the liquid utilized in practicing the invention, the intensity of mixing and the amount of liquid employed. One having ordinary skill in the art will be able to determine what constitutes an effective mixing time without undue experimentation.

If, after gentle mixing, the volume of the initial low bulk density material has not substantially changed, further densification can be achieved by adding additional liquid and continue gentle mixing for a second period of time. Such process can be repeated until the desired decrease in volume of the original low bulk density material is achieved.

Moreover, in some instances, it may be advantageous to proceed in a stepwise manner, as the liquid will subsequently be removed by evaporation. As can easily be appreciated, if less liquid is present, less energy will be required to evaporate the liquid.

The ratio between silica and liquid will vary with the properties of the silica and liquid. For example, a ratio of 30/70 (silica to liquid) may be appropriate. However, the ratio could vary for silica with a very high or low surface area, or for different liquids (with different density for example). What is important is not to excessively wet the powder all the way to reach the gel state, at which point upon drying, the product is not the same. Over wetting will also results in the formation of agglomerates and grit upon drying.

When dried at low temperatures, 50° C. to 120° C., the product retains a hydration layer at the surface of the fumed silica. Heat treatments at higher temperatures i.e., 120° C. to 1000° C., to further modify the silica surface (remove the hydration layer) are possible. Hydration layers on the surface of silica requires high temperatures to be removed. How high depends on the level of dryness required.

It should be understood that the present invention is not limited to densifying materials that have not been subjected to any other densification process. For example, it is within the intended scope of the present invention to further densify, for example, fumed silica, which has previously been partially densified by mechanical or other means.

After the low-density bulk material has been mixed with a liquid for a time effective to decrease the volume of the low bulk density material, the liquid is removed from the mixture. Typically, removal of the liquid from the mixture will be achieved by evaporation. However, depending upon the particular bulk density material and liquid, it may be desirable to effect evaporation of the liquid at atmospheric or reduced pressure, using a rotary drier, a freeze-drier, a fluidized bed drier, a spray drying equipment or similar drying equipment know in the art of powder drying. Other methods for removing the liquid from the powder will be obvious to the skilled artisan. However, evaporation is the most preferred means for removing the liquid.

The time required to remove substantially all of the liquid from the powder will depend primarily on the liquid employed, its vapor pressure, and the size of the batch prepared. Completion of the drying step can easily be determined by inspecting the powder being dried or, more conveniently, merely allowing the drying time to continue for an extended period. Of course, liquid removal is effected much more quickly when the liquid has a low boiling temperature and the liquid/low bulk density mixture is turbulently agitated in the presence of a purge gas such as nitrogen. On the other hand, the process of the present invention occurs more slowly with a high temperature boiling liquid, where the process temperatures are relatively low, where there is no purge gas, and where agitation of the filler/liquid mixture is minimal. The resulting product (after drying) is a free flowing powder containing a limited amount of agglomerates i.e., homogenous powdery material having a bulk density that is much higher than the initial fumed silica powder.

Densification of low bulk density materials in accordance with the present invention provides materials, such as fumed silica which have a substantially greater bulk density, which do not contain unacceptable amounts of agglomerates and grit, and which are readily mixed into other materials. For example, silicone polymer used in making room temperatures vulcanizable (RTV) compositions. The densified fumed silica material can be used as a carrier of a liquid by being “loaded” with an aqueous liquid resulting in a new free flowing product containing the loaded liquid.

### ASPECTS OF THE INVENTION

As will be appreciated from the foregoing description, the present invention is embodied in, and can take the form of various different aspects. For example:

In aspect 1, the invention provides a method for increasing the bulk density of fumed silica comprising:
(A) adding an liquid to a low bulk density fumed silica material dropwise or via spraying;
(B) gently mixing said low bulk density material and said liquid for an amount of time effective to decrease the volume of the original low bulk density material while maintaining the homogeneity of the low bulk density material; and
(C) removing substantially all of said liquid so as to provide a material having an increased bulk density.

In aspect 2, the liquid of the method of the first aspect is an aqueous solution.

In aspect 3, the liquid of the method of aspects 1 or 2 is a polar liquid or a non-polar liquid.

In aspect 4, the liquid of the method of any of aspects 1 to 3 is water.

In aspect 5, liquid of the method of any of aspects 1 to 4 is selected from the group consisting of aqueous solutions of acid, base, alcohol, ester, ketone, salt, soluble polymer, surfactant, enzyme and mixtures thereof.

In aspect 6, the liquid of the method of any of aspects 1 to 5 further comprises colorant, fragrance or mixtures thereof.

In aspect 7, the fumed silica of the method of any of aspects 1 to 6 is hydrophilic, hydrophobic or a mixture thereof.

In aspect 8, the aqueous liquid of the method of aspect 1 is selected from the group consisting of hydrogen peroxide, peracetic acid or mixture thereof.

In aspect 9, the method of aspects 1 to 8 wherein in step (A) the liquid is added to the mixing vessel by spraying while the low bulk density material is gently mixed whereby the homogeneity of the low bulk density material is maintained.

In aspect 10, the method of aspects 1 to 9 wherein the low bulk density fumed silica was previously partially densified.

In aspect 11, the method of aspect 10 wherein the partial densification was effected by mechanical means.

In aspect 12, the method of aspects 1 to 11 wherein removal of substantially all of the aqueous liquid is effected by evaporation.

In some embodiments, the invention herein can be construed as excluding any element or process step that does not materially affect the basic and novel characteristics of the composition or the method for making the composition. Additionally, in some embodiments, the invention can be construed as excluding any element or process step not specified herein.

### EXAMPLES

### Example 1

A total of 80 g of fumed silica was placed in an open tray. A total of 186.7 g of water containing an acid (e.g., phosphoric acid at 85% was added to the liquid to have a final concentration in the liquid of 2% phosphoric acid) was added dropwise under gentle agitation until all the liquid was adsorbed unto the powder. The weight ratio between solid and liquid was 30/70 (solid/liquid).
Fumed silica (Cab-o-sil M5®): 80.0 g
Water+phosphoric acid: 186.7 g
Total: 266.7 g

The mixture (i.e., power filled with liquid) was blended in a Waring Commercial mixer (Waring X-Prep—speed 6.5) with three short mixing bursts of 10 seconds each. A strong densification of the powder was observed during this process.

The powder was then placed in a tray and dried in an oven at 50° C. (122° F.) for several days. The resulting powder was a free flowing powder with a tap density of 0.284 g/ml. The initial tap density of the fumed silica (Cab-o-sil® M5) was 50 g/L or 0.05 g/ml (Untreated silica, Cab-o-sil® M5). This is equivalent to a densification factor of 4.96. The final product was a densified free flowing fumed silica containing phosphoric acid. Tap density was measure according to ASTM D7481-18, Standard Test Methods for Determining Loose and Tapped Bulk Densities of Powders using a Graduated Cylinder.

### Example 2

The same composition as Example 1 (80 g of fumed silica with 186.7 g of water containing phosphoric acid, final concentration in the liquid of 2% phosphoric acid) was made and blended for 1 minute on high speed setting in the Waring blender. The resulting product was a wet saturated product with the aspect of a paste, which upon drying formed a gritty product.

### Example 3

A total of 80 g of fumed silica was placed in an open tray. A total of 170 g of deionized water was added dropwise under gentle agitation until all the liquid was adsorbed unto the powder. The weight ratio between solid and liquid is 32/68 (solid/liquid).
Fumed silica: 80.0 g
DI Water: 170.0 g
Total: 250.0 g

The mixture (i.e., powder filled with liquid) was blended in a commercial Waring mixer with three short mixing bursts of 10 seconds each. A strong densification of the powder was observed during this process.

The powder was then placed in a tray and dried in an oven at 50° C. (122° F.) for several days. The resulting powder was a free flowing powder with a tap density (according to ASTM D7481-18) of 0.23 g/L. The initial tap density of the fumed silica (Cab-o-sil®M5) was 0.05 g/L. The densification factor was 4.6.

The final product was a densified free flowing fumed silica. The product has the same composition as the original bulk powder but with hydrated surfaces and was free of impurities.

### Example 4

Densified fumed silica obtained in example 1 was treated with an aqueous liquid, a 12% peracetic acid solution, whereby the aqueous liquid was absorbed by the densified fumed silica. The resulting powder was a free flowing powder containing the peracetic acid formulation.
Fumed silica (Cab-o-sil® M5): 80.0 g
Peracetic acid at 12% in concentration (SaniDate® 12.0): 186.7 g
Total: 266.7 g

The pre-treatment of fumed silica with phosphoric acid according to the process described above did not modify the absorption properties of the final densified fume silica compared to a product made without the densification treatment.

What is claimed is:

1. A method for increasing the bulk density of fumed silica comprising:
(A) adding an liquid to a low bulk density fumed silica material dropwise or via spraying;
(B) gently mixing said low bulk density material and said liquid for an amount of time effective to decrease the volume of the original low bulk density material while maintaining the homogeneity of the low bulk density material; and
(C) removing substantially all of said liquid so as to provide a material having an increased bulk density.

2. The method of claim 1 wherein the liquid is an aqueous solution.

3. The method of claim 1 wherein the liquid is a polar liquid or a non-polar liquid.

4. The method of claim 1 wherein the liquid is water.

5. The method of claim 1 wherein the liquid is selected from the group consisting of aqueous solutions of acid, base, alcohol, ester, ketone, salt, soluble polymer, surfactant, enzyme and mixtures thereof.

6. The method of claim 5 wherein the liquid further comprises colorant, fragrance or mixtures thereof.

7. The method of claim 1 wherein the fumed silica is hydrophilic, hydrophobic or a mixture thereof.

8. The method of claim 1 wherein aqueous liquid is selected from the group consisting of hydrogen peroxide, peracetic acid or mixture thereof.

9. The method of claim 1 wherein in step (A) the liquid is added to the mixing vessel by spraying while the low bulk density material is gently mixed whereby the homogeneity of the low bulk density material is maintained.

10. The method of claim 1 wherein the low bulk density fumed silica was previously partially densified.

11. The method of claim 10 wherein partial densification was effected by mechanical means.

12. The method of claim 1 wherein removal of substantially all of the aqueous liquid is effected by evaporation.
